(19) United States
(12) Patent Application Publication
(10) Pub. No.: US 2001/0052176 A1
(43) Pub. Date: Dec. 20, 2001

(54) Tool and method for removing transmission to repair clutch

(76) Inventor: James Griffith, Redwood City, CA (US)

Correspondence Address: Robert Samuel Smith, 1263 Emory St., San Jose, CA, 95126, US

(21) Appl. No.: 09/815,095

(22) Filed: Mar. 21, 2001

Related U.S. Application Data
(60) Provisional application No. 60/191,578, filed on Mar. 23, 2000.

(51) Int. Cl. B23P 19/04

(52) U.S. Cl. 29/426.1; 29/267

(57) ABSTRACT

A tool for withdrawing a shifter shaft from a transmission comprising a a smaller cylinder mounted concentrically on a largest cylinder. A concentric bore extending through the tool is dimensioned for a slip fit onto the shifter shaft. An open slot extending from end to end of said tool permits straddling the tool onto the shifter shaft. The smallest cylinder is then engaged with the a hole in the end of the shift lock wherein a flat surface on the outside surface of the smallest cylinder abuts flat section of inside surface of the shift lock. The tool is then used to rotate the shift lock so as to align one or more pins in the interior surface of the lock housing with internal grooves in the shift lock so as to permit separation of the shift lock and shifter shaft from the lock housing.

### CROSS REFERENCE TO EARLIER FILED APPLICATIONS{

This application is a non-provisional application of provisional application 60/191,578 filed Mar. 23, 2000 from which priority is claimed.

### BACKGROUND AND INFORMATION DISCLOSURE

This invention relates to automobile repair and particularly to a method for removing/exchanging the clutch of a vehicle having a stick shift without having to remove the bonnet on the drivers side of the floor.

### BACKGROUND AND INFORMATION DISCLOSURE

A very common repair/maintenance job that must be performed on many vehicles is replacement of the clutch. This job normally requires several hours work for reasons that are best explained with reference to FIGS. 1 and 2 (prior art).

FIG. 1 is a mechanical schematic diagram representing the major components of the typical clutch- transmission system operated with stick shifter. There are shown a main shaft on which are mounted a low speed main gear, a second main gear and a high speed main gear. There is also shown a drive shaft on which are positioned a low speed drive gear, a second speed drive gear and a high speed drive gear. The main shaft is selectively positioned axially under manual control by a shift lever coupled to a shift fork which, in one position causes the low speed main gear to engage the low speed drive gear, in another position causes the second speed drive gear to engage the second speed main gear, and yet another position causes the high speed main gear to engage the high speed drive gear.

FIG. 2 (prior art) shows the parts of the transmission in greater detail. There are shown the the low and reverse sliding gears, the main shaft second speed gear, the transmission case cover plate, reversing gears, rear housing, low gear, second speed gear transmission case, pinion shaft, transmission pinion, transmission flange, flange counter shaft, counter shaft gear and transmission case.

FIG. 3 (prior art) shows an arrangement which is typical with many vehicles according to which an end 14A of the shifter stick 14 is extended through an opening in the transmission housing 19 for engagement with the transmission (transmission not shown in FIG. 3.) The shifter shaft 14 is retained in engagement with the transmission by means of a twist lock retainer 10.

The twist lock retainer 10 is a shift lock 12 mounted on the shifter shaft 14 and a lock housing 16 mounted on the transmission housing 19. The lock housing 16 has an internal surface with two retainer pins 18.extending inwardly. The shift lock 12 has an exterior cylindrical surface with at least one straight groove 22 extending from circumferential groove 24 to one end of the shift lock 12. The shift lock 12 also has a hole 11 (depression) on an end of the shift lock 12 opposite the end of the shift lock 12 with the straight grooves.22. The hole 11 is cylindrical except for a flat 13 on a section of the hole 11.

In order to engage the end 14A of the shifter shaft with the transmission, the shift lock 12 (mounted on the shifter shaft !4) is inserted into and engaged in the lock housing 16 by sliding the retainer pins 18 along the straight grooves 22 and then turning the shift lock 14 so that retainer pins 18 engage circumferential groove 24 in shift lock 12. Spring 20, compressed between the transmission housing and the lock housing 16, secures shift lock 12 inside housing 16.

In order to remove the transmission from the vehicle, it is necessary to first withdraw the shifter shaft 14 from the transmission housing 19 by disengaging the shift lock 12 from the lock housing 16 According to present practice, this is accomplished by removing the boot mounted on

the shifter shaft and removing part of the floor of the vehicle. Boot and floor boards are shown in FIG. 2. The job of removing the boot and part of the floor typically requires one to two hours of time.

### SUMMARY OF THE INVENTION

It is an object of this invention to provide a tool and method for using the tool that eliminates the time required to remove the floor boards and boot in order to remove the transmission. This invention is directed toward a method according to which bolts securing the rear housing are removed which permits the transmission to drop a few inches, This is sufficient distance to permit the mechanic to place the tool of this invention (a yoke) onto the section of shifter shaft between the floor boards and the shift lock. The tool is oriented so that the flat on the outside of the tool is aligned with an internal flat on the inside surface of the shift lock. Then the tool is slid into mating engagement with the shift lock and forced to compress the retaining spring between the twist lock retainer and transmission housing. The mechanic then rotates the tool so that the shift lock is oriented to where retainer pins in the lock housing are aligned with axial grooves 22 in the shift lock permitting withdrawal of the shift lock 12 and shaft 14.

### BRIEF DESCRIPTION OF THE FIGURES

FIG. 1 is a mechanical schematic diagram of a typical transmission.

FIG. 2 shows details of a typical transmission.

FIG. 3 shows details of the stick shift assembly.

FIG. 4 is a perspective view of the tool of this invention.

FIG. 5 is a side view of the tool.

FIG. 6 is a top view of the tool.

FIG. 7 is a bottom view of the tool.

FIG. 8 is a flow chart of the method for using the tool.

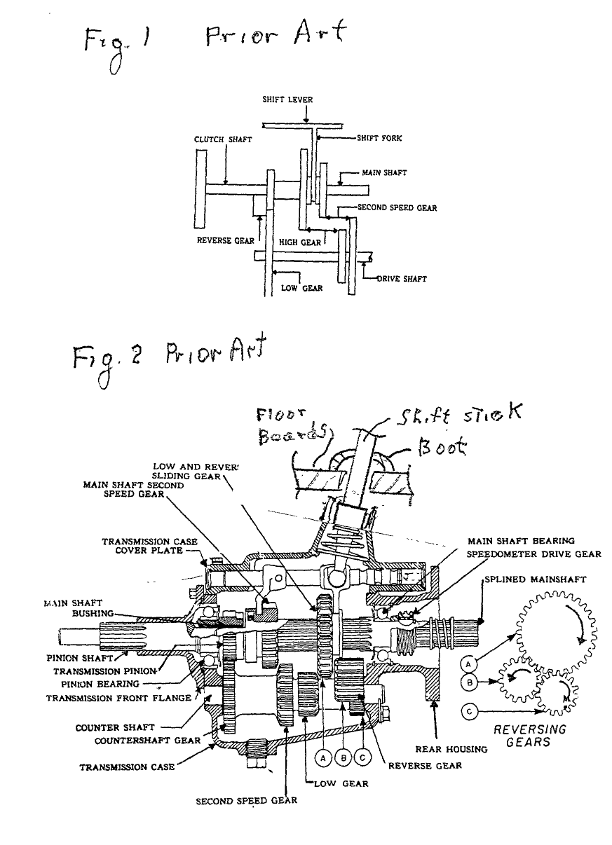

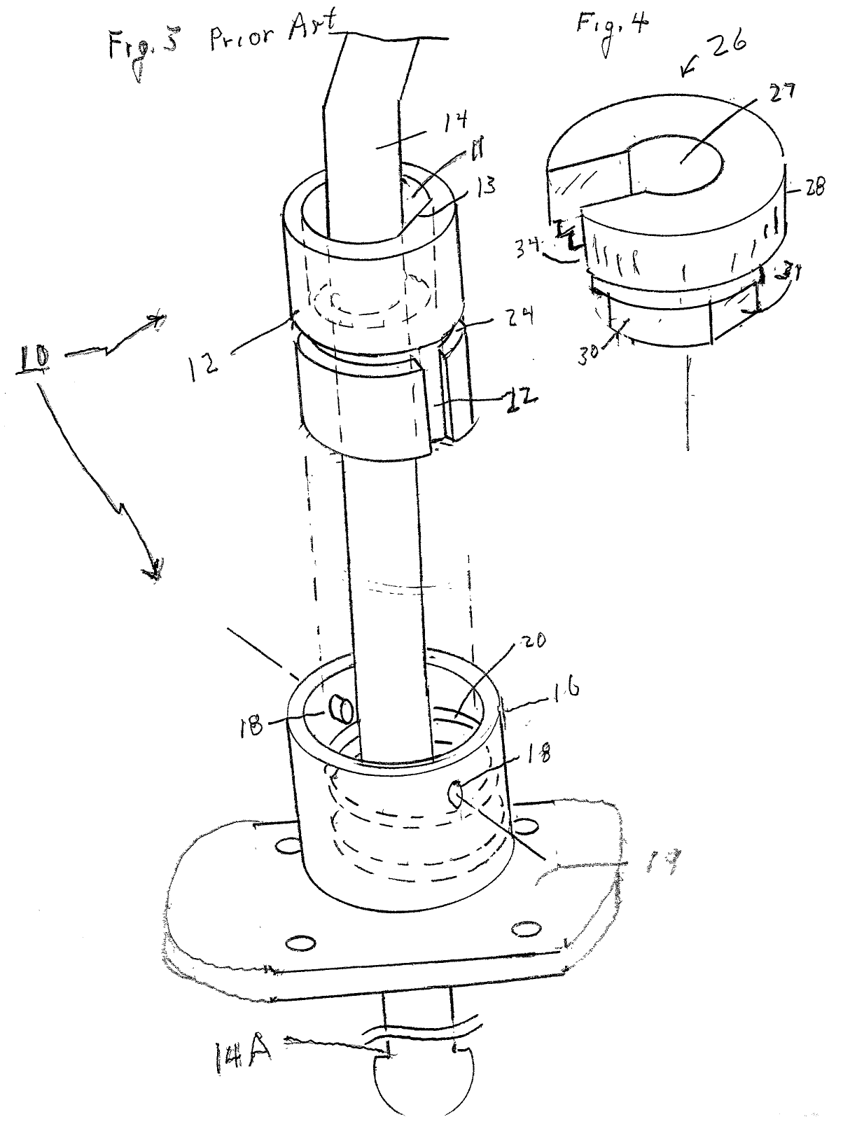

### BEST MODE FOR CARRYING OUT THE INVENTION

Turning now to a discussion of the invention. FIG. 4 is a perspective view of the tool 26 of this invention with which the user, following the method of this invention is enabled to remove the shifter shaft 14 from the transmission while avoiding the necessity of removing the floor boards and bonnet.

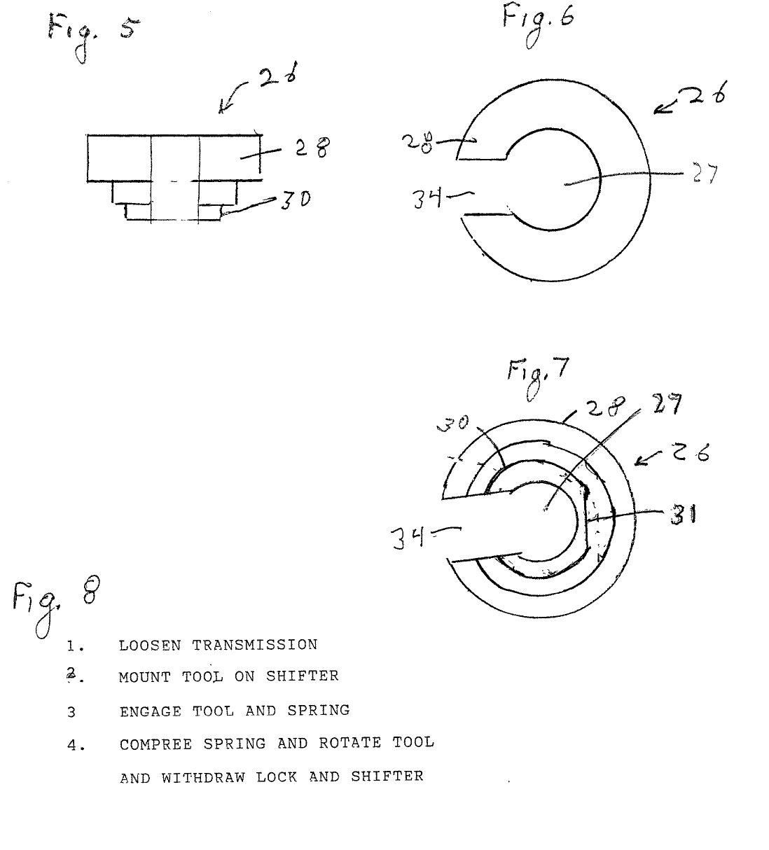

FIG. 5 is a side view, FIG. 6 is one end view, FIG. 7 shows the opposite end view of the tool.

As shown in the figs. the tool 26 has a small cylindrical sections 30, mounted on a large cylindrical section 28 with a central bore 27 extending through both sections from one end to the other end of the tool.

An open slot 34, extending from central bore 34 to the outside surface of the tool, permits mounting the tool onto the shifter shaft 14 and sliding into engagement with shift lock 12.

The large section 28 has an outside diameter that is larger than the opening 11 in the shift lock 12.. The small section 30 has a diameter that permits a slip fit into the cylindrical hole 11 on one end of the shifter lock 12 with a flat 31 on the outside surface of the small section 30 abutting the flat 13 on the internal surface formed by the opening in the end of the shift lock 12.

To disengage the shift lock 12 and shift shaft 14 from the transmission, the tool is mounted on the shift lock and 12 oriented to where flat 13 on the inside surface of the shift lock 12 is engaged with a flat 31 on the outside surface of small section 30. so that the small section 30 mates with the opening 11 of shift lock 12.

FIG. 8 is a flow chart listing the steps according to the method of the invention.

In the first step, rear housing bolts (not shown) are removed permitting the transmission to swing a few inches away from the floor boards and providing access to the shifter shaft 14 and shift lock 12 underneath the floor boards

In step 2, the tool of this invention is positioned on the shifter shaft between the floor boards and the shifter lock 12 secured in lock housing 18.

In step 3, The small section of the tool 26 is oriented to engage with the end of the shift lock as described above.

In step 4, the tool is forced into the lock 12 to compress spring 20 permit the mechanic to turn the tool 26 and shift lock 12 until the groove 22 is aligned with retaining pin 18 This enables the mechanic to slide the shift lock attached to the shifter shaft out of the shift housing 16 and swing off to the side out of the way. Then he can remove the transmission, replace the clutch assembly, reinstall the transmission and reinstall the shifter shaft with the shift lock.

I claim:

1. A tool for aiding in separating a shifter stick (14) from a transmission of a vehicle wherein:
(a) said shifter stick (14) has an end (14A) engaged with said transmission retained by a twist lock retainer (10);
(b) said twist lock retainer {10} is a shift lock (12) securely mounted on said shifter stick (14) and a lock housing (16) securely mounted on a housing (19) of said transmission,
(c) said lock housing (16) has an internal cylindrical surface with at least one retaining pin (18) extending inwardly from said internal cylindrical surface;
(d) said shift lock (12) has an exterior cylindrical surface with a circumferential groove (24) and at least one straight groove (22) extending from one end of said shift lock (12) to said circular groove (24);
(e) said shift lock (12) has a flat end surface opposite said one end with a cylindrical hole 11 concentric with said shifter stick (14), said cylindrical hole having a flat (13) extending from said opposite end of said shift lock (12);
(f) said straight and circular grooves and said at least one retaining pin are arranged in combination to permit engagement of said shift lock with said shift housing inserting the shift lock (12) into the lock housing (16) by sliding the retainer pins 18 along the straight grooves 22 thereby inserting the shift lock (12) into the lock housing (16)
and then turning the shift lock (14) permitting the retainer pins (18) to engage said circumferential groove 24 in shift lock 12;
(g) a spring 20, compressed between the transmission housing and the lock housing (16), thereby securing said shift lock (12) inside said housing (16).
said tool comprising:
a largest cylindrical section (28) having a diameter that is larger than the cylindrical hole (11) in the shift lock (12);
a smaller cylindrical section (30) mounted concentrically on said largest cylindrical section and having a diameter dimensioned to permit sliding said smaller section into the cylindrical hole (11) of the shift lock (16);
said smaller section (30) having an outside surface with a flat (31) on said outside surface operably arranged to permit said smaller section (30) to mate with said cylindrical hole in said opposite end of said shift lock (12);
.said tool having a central bore (27) and a slot (34) between said outside surface and said bore (27) and parallel to said bore (27) and operably arranged to permit inserting said shifter stick (14) through said slot (34) into aligned sliding engagement with said bore (27) then sliding said tool into into mating engagement with said lock housing (12.) permitting that said tool be forced against said shift lock (12) and rotated around said shifter stick (14) to where said at least one retaining pin (18) is aligned with straight groove (22) providing that said shifter stick (14) is enabled to be withdrawn from said transmission.

2. A method for separating a shifter stick (14) from a transmission of a vehicle wherein::
(a) said shifter stick (14) has an end (14A) engaged with said transmission retained by a twist lock retainer (10);
(b) said twist lock retainer {10} is a shift lock (12) securely mounted on said shifter stick (14) and a lock housing (16) securely mounted on a housing (19) of said transmission,
(c) said lock housing (16) has an internal cylindrical surface with at least one retaining pin (18) extending inwardly from said internal cylindrical surface;
(d) said shift lock (12) has an exterior cylindrical surface with a circumferential groove (24) and at least one straight groove (22) extending from one end of said shift lock (12) to said circular groove (24);
(e) said shift lock (12) has a flat end surface opposite said one end with a cylindrical hole 11 concntric with said shifter stick (14), said cylindrical bole having a flat (13) extending from said opposite end of said shift lock (12);
(f) said straight and circular grooves and said at least one retaining pin are arranged in combination to permit engagement of said shift lock with said shift housing inserting the shift lock (12) into the lock housing (16) by sliding the retainer pins 18 along the straight grooves 22 thereby inserting the shift lock (12) into the lock housing (16) and then turning the shift lock (14) permitting the retainer pins (18) to engage said circumferential groove 24 in shift lock 12;
(g) a spring 20, compressed between the transmission housing and the lock housing (16), thereby securing said shift lock (12) inside said housing (16).
said method including the steps in operable order::
(a.) providing a tool having a largest cylindrical section (28) having a diameter that is larger than the cylindrical hole (11) in the shift lock (12);
a smaller cylindrical section (30) mounted concentrically on said largest cylindrical section and having a diameter dimensioned to permit sliding said smaller section into the cylindrical hole (11) of the shift lock (16);
said smaller section (30) having an outside surface with a flat (31) on said outside surface operably arranged to permit said smaller section (30) to mate with said cylindrical hole in said opposite end of said shift lock (12);
said tool having a central bore (27) and a slot (34) between said outside surface and said bore (27) and parallel to said bore (27) and operably arranged to permit inserting said shifter stick (14) through said slot (34) into aligned sliding engagement with said bore (27) then sliding said tool into mating engagement with said lock housing (12.) permitting that said tool be forced against said shift lock (12) and rotated around said shifter stick (14) to where said at least one retaining pin (18) is aligned with straight groove (22) providing that said shifter stick (14) is enabled to be withdrawn from said transmission.
(b) inserting said shifter stick (14) through said slot (34) into aligned sliding engagement with said bore (27);
(c) sliding said tool into mating engagement with said lock housing (12.) permitting that said tool be forced against said shift lock (12);
(d) rotating said tool on said shifter stick (14) to where said at least one retaining pin (18) is aligned with said straight groove (22);
(e) withdrawing said shifter stick (14) from said transmission.
